(19) United States
(12) Patent Application Publication
(10) Pub. No.: US 2016/0179707 A1
(43) Pub. Date: Jun. 23, 2016

(54) Sharing a Common Resource Via Multiple Interfaces

(71) Applicant: Lattice Semiconductor Corporation, Hillsboro, OR (US)

(72) Inventors: Saurabh Chedda, Fremont, CA (US); Kam Chuen Mak, Millbrae, CA (US); Cleo Mui, Hillsboro, OR (US)

(21) Appl. No.: 14/576,245

(22) Filed: Dec. 19, 2014

(51) Int. Cl. G06F 13/16; G06F 9/50

(52) U.S. Cl. CPC G06F 13/1642; G06F 13/1684; G06F 9/5016

(57) ABSTRACT

In one embodiment, an electronic system includes a shared resource and multiple controllers connected to the shared resource by different resource interfaces. In order to coordinate control of the shared resource, which can be controlled by only one controller at a time, the system has an arbitration device that communicates with the multiple controllers over one or more arbitration interfaces (different from the resource interfaces). The arbitration device has a register that stores (i) a controller identification value that identifies one of the controllers and (ii) a control status value that indicates whether the identified controller currently controls the shared resource. Each controller reads data stored in the register to determine whether the shared resource is currently controlled by a controller, and each controller writes data to the first register to secure control of the shared resource, when the shared resource is not currently controlled by a controller.

### BACKGROUND

1. Field of the Invention

The present invention relates to electronic systems and, more specifically but not exclusively, to system architectures having multiple controllers that share a resource.

2. Description of the Related Art

This section introduces aspects that may help facilitate a better understanding of the invention. Accordingly, the statements of this section are to be read in this light and are not to be understood as admissions about what is prior art or what is not prior art.

When more than one controller within an electronic system requires access to a resource, the system needs to support some kind of arbitration methodology that allows a controller to take control of the shared resource safely. In conventional systems, the controllers communicate using the same bus interface in order to establish ownership. In addition, such arbitration methodologies are designed to work only in one implementation domain (e.g., on-chip, on-board, on-system) and will not accommodate controllers that cross domains. Also, such arbitration methodologies are not capable of handling a dynamic number of controllers (i.e., controllers that may come alive or disappear at any time).

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 is a block diagram of a portion of an electronic system having multiple controllers that share a resource;

FIG. 2 is a flow diagram of the processing implemented by each controller of FIG. 1 seeking to secure control of the shared resource; and

FIG. 3 is a flow diagram of the processing implemented by each controller of FIG. 1 seeking to relinquish control of the shared resource.

### DETAILED DESCRIPTION

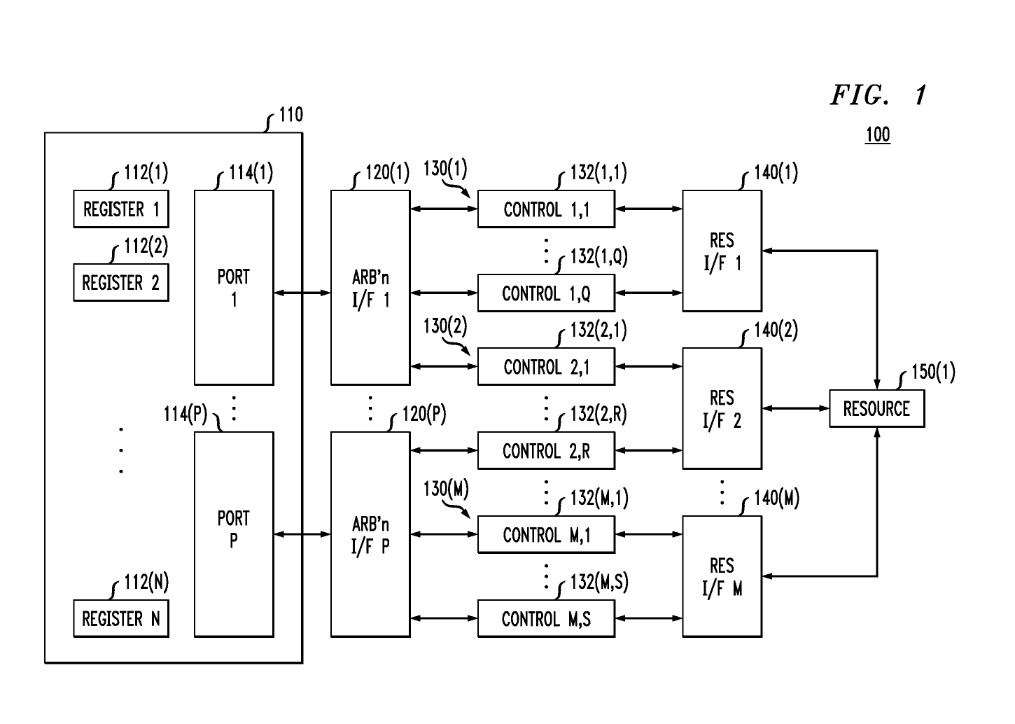

FIG. 1 is a block diagram of a portion of an electronic system 100 having multiple controllers 132 that share a resource 150(1). In some implementations, resource 150(1) is a shared memory device that can be accessed by any one of the controllers 132. In general, resource 150(1) can be any suitable shared electronic device that can be accessed by only one controller 132 at a time.

As shown in FIG. 1, there are M (>=2) different subsets 130(1)-130(M) of controllers, where each subset 130(i) communicates with resource 150(1) via a different resource interface 140(i). In particular, the first subset 130(1), which comprises Q (>=1) controllers 132(1,1)-132(1,Q), communicates with resource 150(1) via resource interface 140(1); the second subset 130(2), which comprises R (>=1) controllers 132(2,1)-132(2,R), communicates with resource 150(1) via resource interface 140(2); and so on until the Mth subset 130(M), which comprises S (>=1) controllers 132(M,1)-132(M,S) and communicates with resource 150(1) via resource interface 140(M). Each resource interface 140(i) may, but does not have to, conform to a different interface standard, such as, for example, the i2c (Inter-Integrated Circuit) standard and the SPI (Serial Peripheral Interface) standard.

Since only one controller 132 can control resource 150(1) at a time, in order to enable the different controllers 132(1,1)-132(M,S) to coordinate their control of resource 150(1), system 100 also includes arbitration device 110, which communicates with the controllers via P (>=1) arbitration interfaces 120(1)-120(P). As shown in FIG. 1, arbitration device 110 has P ports 114(1)-114(P), one for each arbitration interface 120, and N (>=1) registers 112(1)-112(N).

As shown in the exemplary architecture of FIG. 1, arbitration interface 120(1) supports communications between arbitration device 110 and controllers 132(1,1)-132(1,Q) and 132(2,1) via port 114(1), while arbitration interface 120(P) supports communications between arbitration device 110 and controllers 132(2,R) and 132(M,1)-132(M,S) via port 114(P). This exemplary architecture demonstrates that the groupings of the controllers 132 for communication with arbitration device 110 can be (but does not have to be) different from the groupings of those controllers 132 for communication with resource 150(1). Other suitable groupings are also possible. Ports 114(1)-114(P) and arbitration interfaces 120(1)-120(P) enable controllers 132(1,1)-132(M,S) to read data from and write data to register 112(1) in arbitration device 110.

Each arbitration interface 120(i) may, but does not have to, conform to a different interface standard, such as, for example, the JTAG (Joint Test Action Group) standard and the Wishbone standard.

In the exemplary architecture of FIG. 1, register 112(1) in arbitration device 110 is associated with resource 150(1). Although not shown in FIG. 1, when N>1, arbitration device 110 can support arbitration processing for (N−1) other shared resources, where a different register 112(i), i=2, . . . , N, is associated with each different, shared resource, which is shared by a different set of controllers communicating via different resource and arbitration interfaces. Note that these other controllers and resource/arbitration interfaces may be distinct from or may overlap with the controllers 132 and resource/arbitration interfaces 140/120 shown in FIG. 1.

Although arbitration device 110 is shown in FIG. 1 as containing only registers 112 and ports 114, in general, arbitration device 100 may also include other circuitry such as, for example, multiplexers, time-out logic, and counters.

Each register 112(i) in arbitration device 110 is configured to store two values: (i) a controller ID value uniquely identifying the controller that most recently controlled the resource and (ii) a control status value indicating whether or not the identified controller still has control of the resource. Thus, register 112(1) is configured to store (i) a controller ID value that uniquely identifies one of the controllers 132 of FIG. 1 and (ii) a control status value that indicates whether or not that controller 132 still has control of resource 150(1).

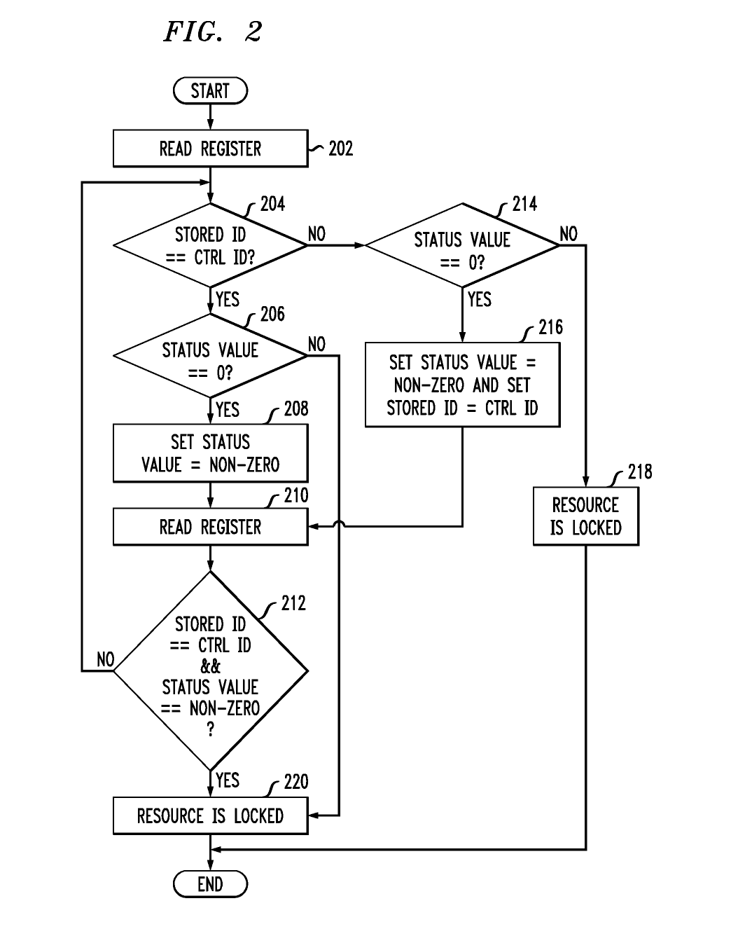

FIG. 2 is a flow diagram of the processing implemented by each controller 132 of FIG. 1 seeking to secure control of resource 150(1). As an exemplary case, the processing of FIG. 2 will be described in the context of controller 132(1,1).

In step 202, controller 132(1,1) reads the contents (i.e., the stored controller ID value and the stored control status value) of register 112(1) in arbitration device 110 via arbitration interface 120(1) and port 114(1).

In step 204, controller 132(1,1) determines whether or not the stored ID value is the same as the (unique) ID value of controller 132(1,1). If so, then controller 132(1,1) is the controller that most recently had control of resource 150(1), and processing continues to step 206. Otherwise, controller 132(1,1) is not the controller that most recently had control of resource 150(1), and processing continues to step 214.

In step 206, controller 132(1,1) determines whether the stored control status value is equal to zero. If so, then no controller currently has control of resource 150(1), and processing continues to step 208. If not, then controller 132(1,1) currently has control of resource 150(1) and processing continues to step 220.

In step 214, controller 132(1,1) determines whether the stored control status value is equal to zero. If so, then no controller currently has control of resource 150(1), and processing continues to step 216. If not, then another controller currently has control of resource 150(1) and processing continues to step 218. If processing reaches step 218, it means that some other controller currently has control of resource 150(1), and the processing of FIG. 2 ends. Note that step 218 is not really a function step, but rather a state.

If processing reaches step 216, it means that some other controller most recently controlled resource 150(1), but that other controller does not currently control resource 150(1). In that case, in step 216, controller 132(1,1) secures control of resource 150(1) by storing (i) a control status value other than zero (e.g., one) and (ii) its ID value into register 112(1) via arbitration interface 120(1) and port 114(1), and processing continues to step 210.

If processing reaches step 208, it means that the stored ID value identifies controller 132(1,1), but controller 132(1,1) does not currently have control of resource 150(1). In that case, in step 208, controller 132(1,1) secures control of resource 150(1) by storing a control status value other than zero (e.g., one) into register 112(1) via arbitration interface 120(1) and port 114(1). Processing then continues to step 210.

If processing reaches step 210, it means that controller 132(1,1) just took actions to secure control of resource 150(1). To confirm that it actually does have control of resource 150(1), in step 210, controller 132(1,1) re-reads the contents of register 112(1), and, in step 212, controller 132(1,1) determines whether its ID value is the stored ID value and whether the stored control status value is not zero. If so, then controller 132(1,1) has confirmed that it currently has control of resource 150(1), and processing continues to step 220. If not, then controller 132(1,1) determines that it currently does not have control of resource 150(1), and processing returns to step 204 to start the process over.

If processing reaches step 220, it means that controller 132(1,1) currently has control of resource 150(1), and the processing of FIG. 2 ends. Note that step 220 is not really a function step, but rather a state.

Those skilled in the art will appreciate that the specific logic flow of FIG. 2 is just one possible way of implementing the functionality of securing control of resource 150(1).

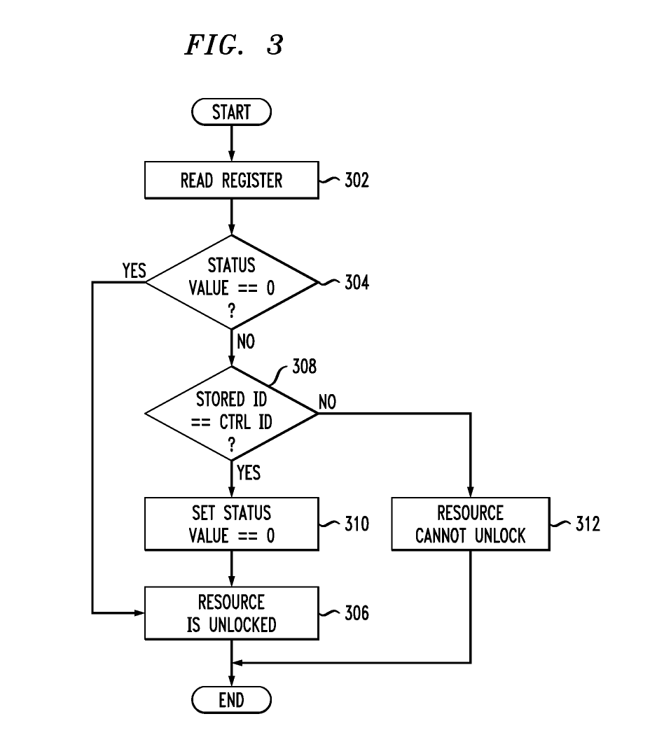

FIG. 3 is a flow diagram of the processing implemented by each controller 132 of FIG. 1 seeking to relinquish control of resource 150(1). As an exemplary case, the processing of FIG. 3 will be described in the context of controller 132(1,1).

In step 302, controller 132(1,1) reads the contents of register 112(1), as in step 202 of FIG. 2.

In step 304, controller 132(1,1) determines whether the stored control status value is zero. If so, then resource 150(1) is already not controlled by controller 132(1,1) or any other controller, and processing continues to step 306. If not, then resource 150(1) is currently controlled by some controller 132 in FIG. 1, and processing continues to step 308.

In step 308, controller 132(1,1) determines whether the stored ID value is equal to its ID value. If so, then controller 132(1,1) currently controls resource 150(1), and processing continues to step 310, where controller 132(1,1) relinquishes control of resource 150(1) by setting the stored control status value in register 112(1) to zero. Processing then continues to step 306.

If, in step 308, controller 132(1,1) determines that the stored ID value is not equal to its ID value, then it does not currently control resource 150(1). In that case, processing continues to step 312, where controller 132(1,1) determines that it cannot relinquish resource 150(1) because it is currently controlled by another controller, and the processing of FIG. 3 ends. Note that step 312 is not really a function step, but rather a state.

If processing reaches step 306, it means that controller 132(1,1) does not currently control resource 150(1), and the processing of FIG. 3 ends. Note that step 312 is not really a function step, but rather a state.

Those skilled in the art will appreciate that the specific logic flow of FIG. 3 is just one possible way of implementing the functionality of relinquishing control of resource 150(1).

In certain embodiments, the present invention provides a mechanism and a protocol having one or more of the following features:
Supporting multiple controllers and multiple shared resources;
Arbitrating between multiple controllers requesting ownership of a shared resource, managing ownership of a shared resource, and communicating with all controllers on the state of their requests;
Allowing controllers to take ownership of a shared resource for a duration of time that can span more than one transaction;
Allowing controllers to take ownership and subsequently relinquish ownership of a shared resource at their volition without having to continuously check ownership of the shared resource once it already has ownership;
Allowing controllers to request ownership from different interfaces and domains;
Allowing controllers to join and leave the system at any given time without the burden of informing the other controllers;
Enabling resource sharing across different implementation domains;
Not imposing a static limit on the number of controllers at runtime (that is, controllers are free to join and leave the system when they want to);
Not imposing the restriction that all controllers communicate via a common interface; and
Not imposing a restriction on whether the controller has access to the shared resource for a single transaction or a series of transactions.

Embodiments of the invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An electronic system comprising:
a first shared resource (e.g., 150(1));
a first set of two or more controllers (e.g., 132(1,1)-132(M,S)) comprising:
a first subset (e.g., 130(1)) of one or more controllers (e.g., 132(1,1)-132(1,Q)) configured to control the first shared resource via a first resource interface (e.g., 140(1)); and
a second subset (e.g., 130(2)) of one or more controllers (e.g., 132(2,1)-132(2,R)) configured to control the first shared resource via a second resource interface (e.g., 140(2)) different from the first resource interface;
an arbitration device (e.g., 110) configured to communicate with the first set of two or more controllers via a first set of one or more arbitration interfaces (e.g., 120(1)-120(P)), wherein:
at most one controller can control the shared resource at a time;
the arbitration device comprises a first register (e.g., 112(1) for the first shared resource;
the first register is configured to store (i) a controller identification value identifying one of the controllers and (ii) a control status value indicating whether the identified controller currently has control of the first shared resource;
each controller is configured to read data stored in the first register to determine whether the first shared resource is currently controlled by one of the controllers;
each controller is configured to write data to the first register to secure control of the first shared resource, when the first shared resource is not currently controlled by one of the controllers; and
each controller is configured to write date to the first register to relinquish control of the first shared resource.

2. The system of claim 1, wherein the first and second resource interfaces correspond to different interface standards.

3. The system of claim 1, wherein a controller of the first subset is unable to communicate with a controller of the second subset over any one of the resource interfaces.

4. The system of claim 1, wherein:
the first set of one or more arbitration interfaces comprises two or more different arbitration interfaces; and
the arbitration device is configured to communicate with the first set of controllers via the first set of two or more different arbitration interfaces.

5. The system of claim 4, wherein each controller is configured to read from or write to the first register via a corresponding arbitration interface.

6. The system of claim 5, wherein association of the controllers to the two or more different arbitration interfaces is independent of association of the controllers to the two or more different resource interfaces.

7. The system of claim 1, further comprising one or more additional shared resources, wherein, for each additional shared resource:
an additional set of two or more controllers is configured to control the additional shared resource via an additional set of two or more different resource interfaces, wherein at most one controller in the additional set can control the additional shared resource at a time via one of the different resource interfaces of the additional set;
the arbitration device is configured to communicate with the additional set of controllers via an additional set of one or more arbitration interfaces;
the arbitration device comprises an additional register for the additional shared resource;
the additional register is configured to store (i) a controller identification value identifying one of the controllers of the additional set and (ii) a control status value indicating whether the identified controller currently has control of the additional shared resource;
each controller in the additional set is configured to read data stored in the additional register to determine whether the additional shared resource is currently controlled by one of the controllers in the additional set;
each controller in the additional set is configured to write data to the additional register to secure control of the additional shared resource, when the additional shared resource is not currently controlled by one of the controllers in the additional set; and
each controller in the additional set is configured to write data to the additional register to relinquish control of the additional shared resource.

8. The system of claim 7, wherein the first set of controllers is different from at least one additional set of controllers.

9. The system of claim 7, wherein the first set of two or more different resource interfaces is different from at least one additional set of two or more different resource interfaces.

10. The system of claim 7, wherein the first set of one or more arbitration interfaces is different from at least one additional set of one or more arbitration interfaces.

11. One of the controllers in the electronic system of claim 1.

12. The arbitration device of claim 1.
